(19) United States
(12) Patent Application Publication
(10) Pub. No.: US 2022/0286305 A1
(43) Pub. Date: Sep. 8, 2022

(54) SECURED HD MAP SERVICES USING BLOCKCHAIN

(71) Applicant: Intel Corporation, Santa Clara, CA (US)

(72) Inventors: Soo Jin Tan, Shanghai (CN); Qian Li, Beaverton, OR (US); Leifeng Ruan, Beijing (CN)

(21) Appl. No.: 17/638,728

(22) PCT Filed: Sep. 27, 2019
(86) PCT No.: PCT/CN2019/108385

§ 371 Date: Feb. 25, 2022

(51) Int. Cl. H04L 9/00; H04L 9/40; H04L 9/30; G01C 21/00

(52) U.S. Cl. CPC H04L 9/50; H04L 63/0823; H04L 9/30; G01C 21/3859; G01C 21/3885; H04L 2209/84; H04W 4/44

(57) ABSTRACT

Various systems and methods for implementing secure high-definition map services are described herein. A system for implementing secure high-definition map services includes a processor subsystem; and a storage including instructions, which when executed by the processor subsystem, cause the processor subsystem to: receive map data from a remote data source; authenticate the remote data source; obtain an identifier of the remote data source; add the map data to an entry in an immutable log when the remote data source is authenticated, the entry having an entry identifier; store an association between the identifier of the remote data source and the entry identifier in a secure store; and incorporate the map data into a master map.

### TECHNICAL FIELD

The present disclosure relates generally to high-definition (HD) map implementations, and specifically to implementing secured HD map services using a blockchain.

### BACKGROUND

A high-definition (HD) map includes extremely highly precise data allowing autonomous vehicles to navigate using map data. HD maps may be precise down to the centimeter level. This precision provides autonomous vehicles the information needed to safely navigate over road segments. HD maps may be generated using sensors attached to a vehicle that is driven over the road segment, surveying the road segment, using roadside units that monitor the road segment, or using other methods.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a schematic drawing illustrating a vehicle, according to an embodiment;

FIG. 2 is a diagram illustrating a hardware and software architecture of a computerized component, such as the computerized component described above, in which various interfaces between hardware components and software components are shown, according to an embodiment;

FIG. 3 illustrates devices and network entities in a multi-access communications environment, according to an embodiment;

FIG. 4 illustrates an operative arrangement of network and vehicle user equipment, in which various embodiments may be practiced;

FIG. 5 is a diagram illustrating blockchain-based secure map data sharing, according to an embodiment;

FIG. 6 is a swim lane diagram illustrating a process for secure mapping operations, according to an embodiment;

FIG. 7 is a flowchart illustrating a method for providing secure mapping operations, according to an embodiment;

FIG. 8 is a flowchart illustrating a method for providing secure mapping operations, according to an embodiment; and

FIG. 9 is a block diagram illustrating a machine in the example form of a computer system, within which a set or sequence of instructions may be executed to cause the machine to perform any one of the methodologies discussed herein, according to an embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

With the emergence of fully and semi-autonomous vehicles (AVs), high-definition (HD) maps are increasingly important. The integrity, accuracy, and provenance of HD maps are crucial and need to be secured to ensure that adoption of AVs continues. An HD map is composed of multiple tiles. The tiles are stitched together by an AV and used to navigate over a road segment. Tiles may be of various sizes, but in some cases, the tile size is standardized.

An HD map may be generated by vehicles, roadside units (RSUs), surveys, satellite imagery, and the like. For instance, vehicles may be equipped with sensors that are used to measure aspects of the environment around the vehicle and capture map objects and road data. Sensors may include visible light cameras, light detection and ranging (LIDAR), global positioning system (GPS) units, inertial measurement units (IMU), infrared sensors, and the like. Data may be collected to determine map objects (e.g., lane boundaries, intersections, traffic signs, traffic lights, etc.). Real-time information may also be obtained, such as traffic levels, weather conditions, road conditions, accidents, etc. Using multiple vehicles over the same road segment provides a high-redundancy and highly-accurate map tile of the road segment. The map tile may be uploaded to a cloud server, edge network, or other service to collect the map tile, store the map tile, combine with other tiles, and share the tile. A malicious actor may upload intentionally inaccurate map tiles to cause havoc. What is needed is a way to secure the map tile origination operations.

This document describes a secure and trusted environment that provides traceability of map tiles when created, collected, or constructed. The secure and trusted environment ensures the genuineness of the data while maintaining the anonymity of the map tile contributor. As map data is uploaded, it is validated and authenticated. A public immutable log (e.g., distributed ledger, blockchain, etc.) is used to track contributions of map data that is added to the master map database. The master map database may include a global map of a larger region (e.g., a state, a country, the entire world, etc.). As a result, users of the map data are provided the assurance that the map data is valid and tracked so that in the event of a data error, the cause may be traced to the contributor of the map data.

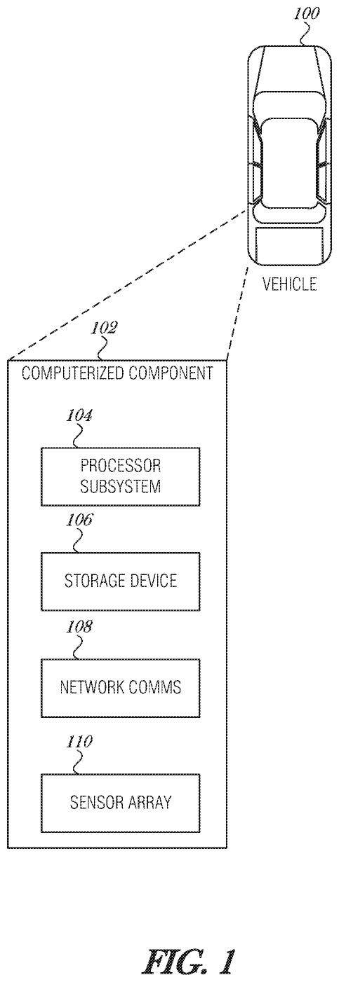

FIG. 1 is a schematic drawing illustrating a vehicle 100, according to an embodiment. FIG. 1 includes one or more computerized components 102 incorporated into the vehicle 100. The vehicle 100 may be of any type of vehicle, such as a commercial vehicle, a consumer vehicle, a recreation vehicle, a car, a truck, a motorcycle, airplane, or a boat. The vehicle 100 may be an autonomous or semi-autonomous vehicle. In general, the computerized component 102 includes a processor subsystem 104, and a storage device 106. The processor subsystem 104 may include one or more processors, each with one or more cores. Additionally, the processor subsystem 104 may be disposed on one or more physical devices. The processor subsystem 104 may include one or more specialized processors, such as a graphics processing unit (GPU), a digital signal processor (DSP), a field programmable gate array (FPGA), or a fixed function processor.

The storage device 106 includes one or more devices used to store data. A storage device 106 may include any non-transitory mechanism for storing information in a form readable by a machine (e.g., a computer). For example, a storage device 106 may include read-only memory (ROM), random-access memory (RAM), magnetic disk storage media, optical storage media, flash-memory devices, or other storage devices and media.

The computerized component 102 may be installed as an after-market component of the vehicle 100, or may be provided as a manufacturer option. As an after-market component, the computerized component 102 may plug into the existing infrastructure in the vehicle 100.

The computerized component 102 may support, enable, integrate, provide, or be used in one of many subsystems in a vehicle 100, including but not limited to engine control systems, navigation systems, driver assistance systems, safety systems, infotainment systems, and the like.

For instance, the computerized component 102 may support, enable, integrate, or provide a sensor array 110, which may include various forward, side, and rearward facing cameras, radar, LIDAR, ultrasonic, GPS, or other sensors.

In another aspect, the computerized component 102 may support, enable, or be integrated with various other sensors as part of the sensor array 110, such as driver identification sensors (e.g., a seat sensor, an eye tracking and identification sensor, a fingerprint scanner, a voice recognition module, or the like), occupant sensors, or various environmental sensors to detect wind velocity, outdoor temperature, barometer pressure, rain/moisture, or the like.

In another aspect, the computerized component 102 may support, enable, or be integrated with an on-board diagnostics system to record vehicle operation and other aspects of the vehicle's performance, maintenance, or status. The on-board diagnostics system may determine various vehicle state data, such as whether the windshield wipers are activated, whether the driving lights are activated, whether a sunroof is open or closed, etc.

Components of the computerized component 102 may communicate using a network communication circuitry 108 to communicate over various networks, which may include local-area networks (LAN), wide-area networks (WAN), wireless networks (e.g., IEEE 802.11 or cellular network), the Public Switched Telephone Network (PSTN) network, ad hoc networks, personal area networks (e.g., Bluetooth), vehicle-based networks (e.g., Controller Area Network (CAN) BUS), or other combinations or permutations of network protocols and network types. The network may include a single local area network (LAN) or wide-area network (WAN), or combinations of LANs or WANs, such as the Internet. The various devices coupled to the network may be coupled to the network via one or more wired or wireless connections.

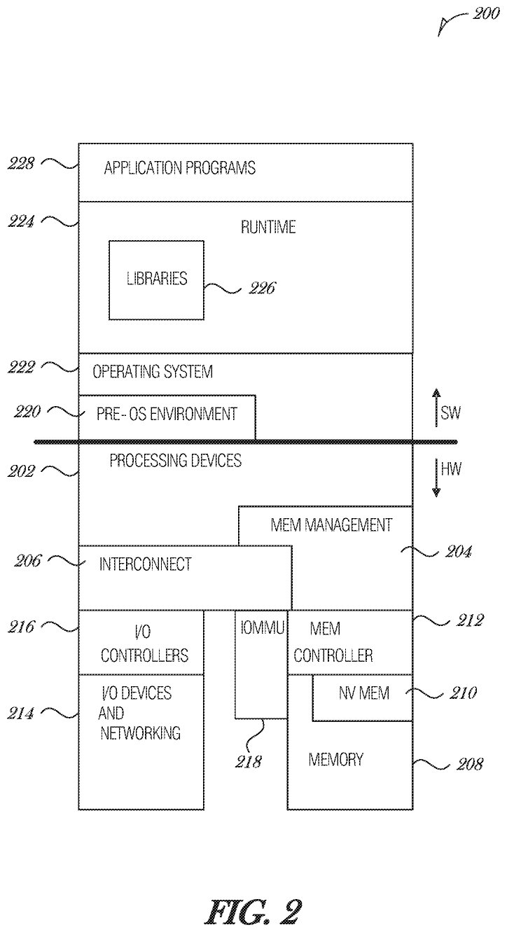

FIG. 2 is a diagram illustrating a hardware and software architecture 200 of a computerized component, such as the computerized component 102 described above, in which various interfaces between hardware components and software components are shown, according to an embodiment. As indicated in FIG. 2 by “HW,” hardware components are represented below the divider line, whereas software components (denoted by “SW”) reside above the divider line. On the hardware side, processing devices 202 (which may include one or more microprocessors, digital signal processors, etc., each having one or more processor cores, are interfaced with memory management device 204 and system interconnect 206. Memory management device 204 provides mappings between virtual memory used by processes being executed, and the physical memory. Memory management device 204 may be an integral part of a central processing unit which also includes the processing devices 202.

Interconnect 206 includes a backplane such as memory, data, and control lines, as well as the interface with input/output devices, e.g., Peripheral Component Interconnect (PCI), Universal Serial Bus (USB), etc. Memory 208 (e.g., dynamic random-access memory—DRAM) and non-volatile memory 210 such as flash memory (e.g., electrically-erasable read-only memory—EEPROM, NAND Flash, NOR Flash, etc.) are interfaced with memory management device 204 and interconnect 206 via memory controller 212. This architecture 200 may support direct memory access (DMA) by peripherals in some embodiments. I/O devices, including video and audio adapters, non-volatile storage, external peripheral links such as USB, Bluetooth, etc., as well as network interface devices such as those communicating via Wi-Fi or LTE-family interfaces, are collectively represented as I/O devices and networking 214, which interface with interconnect 206 via corresponding I/O controllers 216.

In a related embodiment, input/output memory management unit (IOMMU) 218 supports secure direct memory access (DMA) by peripherals. IOMMU 218 may provide memory protection by meditating access to memory 208 from I/O device 214. IOMMU 218 may also provide DMA memory protection in virtualized environments, where it allows certain hardware resources to be assigned to certain guest VMs running on the system, and enforces isolation between other VMs and peripherals not assigned to them.

On the software side, a pre-operating system (pre-OS) environment 220, which is executed at initial system start-up and is responsible for initiating the boot-up of the operating system. One traditional example of pre-OS environment 220 is a system basic input/output system (BIOS). In present-day systems, a unified extensible firmware interface (UEFI) may be implemented. Pre-OS environment 220, is responsible for initiating the launching of the operating system, but also provides an execution environment for embedded applications.

A portion of the pre-OS environment 220 is the Memory Reference Code (MRC). The MRC is responsible for initializing the memory 208. This is performed as part of a POST process. The MRC firmware saves memory training data to non-volatile memory 210 to improve boot times on subsequent boots. On subsequent boots, so long as no exception cases have occurred, the data from non-volatile memory 210 is re-used.

Operating system (OS) 222 provides one or more kernels that control the hardware devices, manages memory access for programs in memory, coordinates tasks and facilitates multi-tasking, organizes data to be stored, assigns memory space and other resources, loads program binary code into memory, initiates execution of the application program which then interacts with the user and with hardware devices, and detects and responds to various defined interrupts. Also, operating system 222 provides device drivers, and a variety of common services such as those that facilitate interfacing with peripherals and networking, that provide abstraction for application programs so that the applications do not need to be responsible for handling the details of such common operations. Operating system 222 additionally provides a graphical user interface (GUI) that facilitates interaction with the user via peripheral devices such as a monitor, keyboard, mouse, microphone, video camera, touchscreen, and the like.

Runtime system 224 implements portions of an execution model, including such operations as putting parameters onto the stack before a function call, the behavior of disk input/output (I/O), and parallel execution-related behaviors. Runtime system 224 may also perform support services such as type checking, debugging, or code generation and optimization.

Libraries 226 include collections of program functions that provide further abstraction for application programs. These include shared libraries, dynamic linked libraries (DLLs), for example. Libraries 226 may be integral to the operating system 222, runtime system 224, or may be added-on features, or even remotely-hosted. Libraries 226 define an application program interface (API) through which a variety of function calls may be made by application programs 228 to invoke the services provided by the operating system 222. Application programs 228 are those programs that perform useful tasks for users, beyond the tasks performed by lower-level system programs that coordinate the basic operability of the computing device itself. Application programs 228 may include in-dash infotainment systems (e.g., navigation, radio programming, vehicle diagnostics, social media, etc.), emergency services, vehicle concierge, and the like. Application programs 228 may also be used to control various sensors or other subsystems in a vehicle, such as camera views, LIDAR sensitivity, advanced driver-assistance systems (ADAS), etc.

Depending on the design of the computerized component, some aspects that are described in FIG. 2 may be omitted or combined with other aspects.

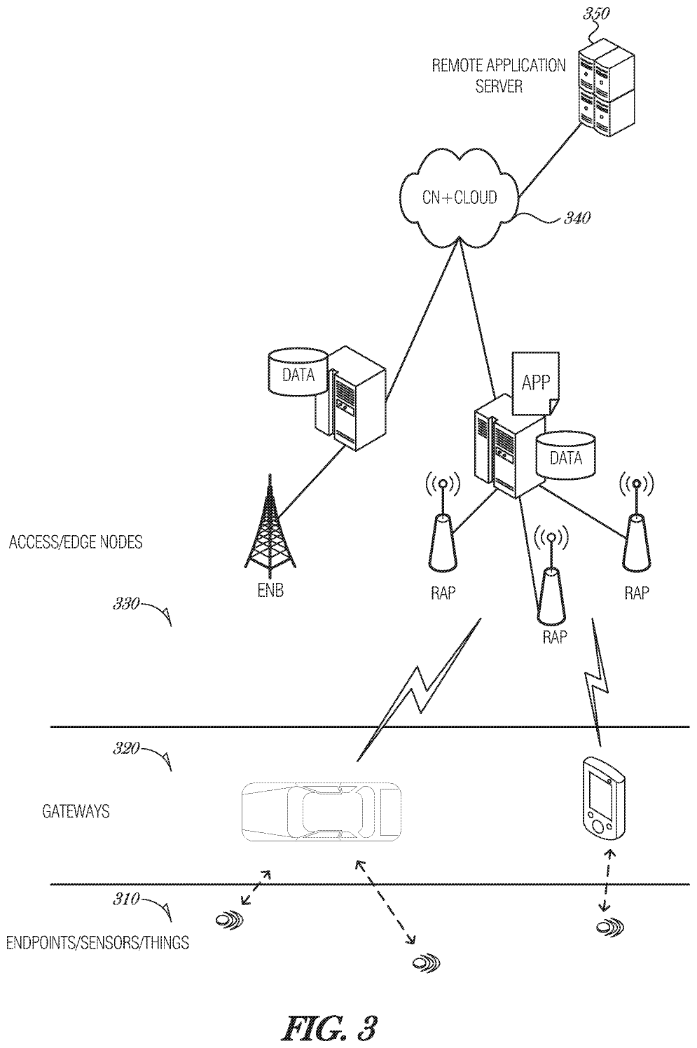

FIG. 3 illustrates devices and network entities in a multi-access communications environment, according to an embodiment. FIG. 3 specifically illustrates the different layers of communication occurring within the environment, starting from endpoint sensors or things 310 (e.g., operating in an IoT network topology). The layers increase in sophistication to gateways (e.g., vehicles) or intermediate nodes 320, which facilitate the collection and processing of data from endpoints 310. Higher up, the layers further increase in processing and connectivity sophistication to access or edge nodes 330 (e.g., roadside units operating as edge computing nodes), such as may be embodied by base stations (eNbs), roadside access points (RAPs) or roadside units (RSUs), nodes, or servers. A core network (CN) or cloud setting 340 is the highest layer with the most sophistication of processing and connectivity features. The processing at the core network or cloud setting 340 may be enhanced by network services as performed by a remote application server 350 or other cloud services.

As shown, in the scenario of FIG. 3, the endpoints 310 communicate various types of information to the gateways or intermediate nodes 320; however, due to the mobility of the gateways or intermediate nodes 320 (such as in a vehicle or mobile computing device), multiple access points or types of access points may be used for network access, multiple distinct services and servers may be used for computing operations, multiple distinct applications and data may be available for processing, and multiple distinct network operations may be offered as the characteristics and capabilities of the available network services and network pathways change. In particular, the environment may involve aspects of Vehicle-to-Infrastructure (V2I), Vehicle-to-Vehicle (V2V), and Vehicle-to-Everything (V2X) services from vehicle user equipment (UE) or human-operated portable UEs (e.g., mobile smartphones and computing devices), which introduces significant complexity for computing services and network usage.

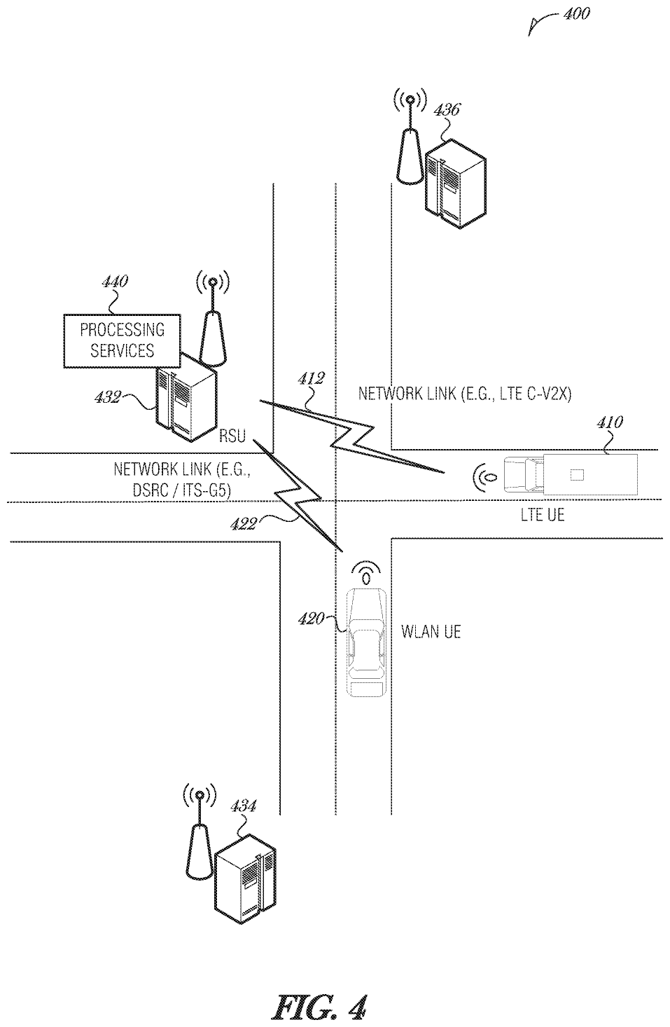

FIG. 4 illustrates an operative arrangement 400 of network and vehicle user equipment, in which various embodiments may be practiced. In arrangement 400, vehicle user equipment (vUE) 410, 420 may operate with a defined communication system (e.g., using an LTE C-V2X WWAN 412, or a SRC/ETSI ITS-G5 (WLAN) communication network 422, etc.). In embodiments, a roadside unit (RSU) 432 (or RAP) may provide processing services 440 by which the vUEs 410 and 420 may communicate with one another (or to other services), execute services individually and with each other, or access similar aspects of coordinated or device-specific edge computing services.

In embodiments, the processing services 440 may be provided by a multi-access edge computing (MEC) host (e.g., an ETSI MEC host), MEC platform, or other MEC entity implemented in or by hardware of the RSU 432. In this example, the RSU 432 may be a stationary RSU, such as an eNB-type RSU or other like infrastructure. In other embodiments, the RSU 432 may be a mobile RSU or a UE-type RSU, which may be implemented by a vehicle (e.g., a truck), pedestrian, or some other device with such capabilities. In these cases, mobility issues may be managed in order to ensure a proper radio coverage of the applicable services. For instance, mobility may be managed as the respective vUEs 410, 420 transition from, and to, operation at other RSUs, such as RSUs 434, 436, and other network nodes not shown.

Using the systems described in FIGS. 1-4, vehicles, roadside infrastructure, and other sensors that are near the road may be used to collect map data and generate a local map. The local map may be used to create a map tile. The map tile may be stored in a blockchain to log its creation and origin. The new map tile may then be added to a master HD map for use by clients.

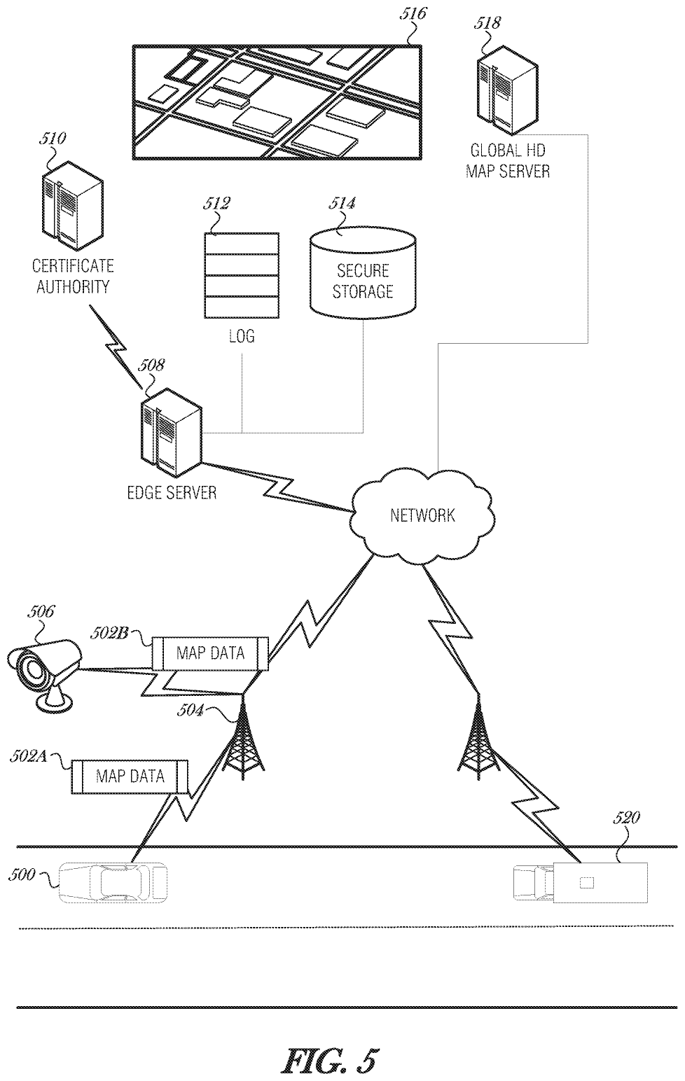

FIG. 5 is a diagram illustrating blockchain-based secure map data sharing, according to an embodiment. A vehicle 500 generates map data 502A for use in an HD map (e.g., global HD map 516). The map data 502A may include point cloud data, image data, or other sensor data used to construct representations of road characteristics, structures, vehicles, and other features around a road segment. The map data 502A may be used to revise, update, or create a map tile. The vehicle 500 uploads the map data 502A to a network appliance 504, which may be a roadside unit (RSU), base station, roadside access point (RAP), router, or the like. Additionally or alternatively, roadside sensors 506 may be used to capture map data 502B and upload it to the network appliance 504. It is understood that the roadside sensors 506 and network appliance 504 may be packaged together in the same enclosure, or on the same packaging or board. The map data 502A-B may be communicated using a communication system (e.g., using an LTE C-V2X WWAN, or a SRC/ETSI ITS-G5 (WLAN) communication network, etc.) as described in FIG. 4. The map data submitter (e.g., vehicle 500 or roadside sensor 506) may be issued a certificate with a private key. The private key is used to digitally sign the map data. A certificate, which includes the corresponding public key, is transmitted to the network appliance 504 along with the signed map data.

The network appliance 504 transmits the map data 502A-B and certificate to an edge server 508. The network appliance 504 may be co-located with the edge server 508, or be integrated with the edge server 508. Alternatively, the edge server 508 may be configured to interface with multiple network appliances 504 installed near the same or different roads.

The edge server 508 receives the map data 502A-B and authenticates its source (e.g., vehicle 500 or network appliance 504) using the public key associated with the certificate. A certificate authority (CA) 510 may be contacted to verify the authenticity of the certificate. The CA 510 may be a vehicle original equipment manufacturer (OEM), a map operator or distributor, of a publicly-available commercial CA such as Comodo or DigiCert.

After authenticating the source, the edge server 508 decrypts the map data, processes it to conform to a map tile data format, and stores the map tile data in an entry in a public immutable log 512 (e.g., block in a blockchain). Immutable logs, such as distributed ledgers and blockchains provide a decentralized database or log of records (e.g., entries or blocks) that provide an auditable transaction history and are visible to everyone on the network. The records are unchangeable and the log is append-only so that it is immutable.

An association between the entry and the source is ascertained and stored in a secure storage 514. The source has a unique identifier, which may be a network address, public key, arbitrary global unique identifier assigned to hardware in a vehicle or at the source, or the like. The unique identifier of the source is stored with an entry identifier (e.g., block identifier). This may be stored in a blockchain or other immutable, secure storage.

The map tile data 502A-B is then incorporated into a master or global HD map 516, which may include map tiles of a region or of the entire world. The master or global HD map 516 may be stored and managed at a master map server 518, which may be a different system than the edge server 508. Communications between the edge server 508 and the master map server 518 may be encrypted. For instance, the edge server 508 may use a private key to sign and encrypt the map data. The master map server 518 may then use a public key associated with the edge server 508 to decrypt it. Alternatively, the edge server 508 may obtain a public key of the master map server 518, and encrypt the map data with the master map server's public key, allowing the master map server 518 to decrypt it using a corresponding private key. As another alternative, a symmetric key may be used to encrypt and decrypt the map data. The master map server 518 may then check for authenticity and decrypt the map data 502A-B before integrating it with the master or global HD map 516.

Map tile data is provided to subscribers 520 (e.g., other vehicles, autonomous drones, planes, boats, etc.) that use the map services provided by the edge server 508 or master map server 518. If the consuming device discovers that the map information is inaccurate or outdated, it may report back to the map service (e.g., edge server 508 or master map server 518), which may use the public immutable log 512 and the secure storage 514 to trace the source of the inaccuracy.

Immutable logs (e.g., blockchains) may be used for a region such that each edge server 508 may maintain its own log for a region that it services. Such a configuration reduces the size of the log and may reduce computation time and other management overhead. Logs for one region may be shared with other regions to form a population of peers that each have a copy of the log for auditing and immutability.

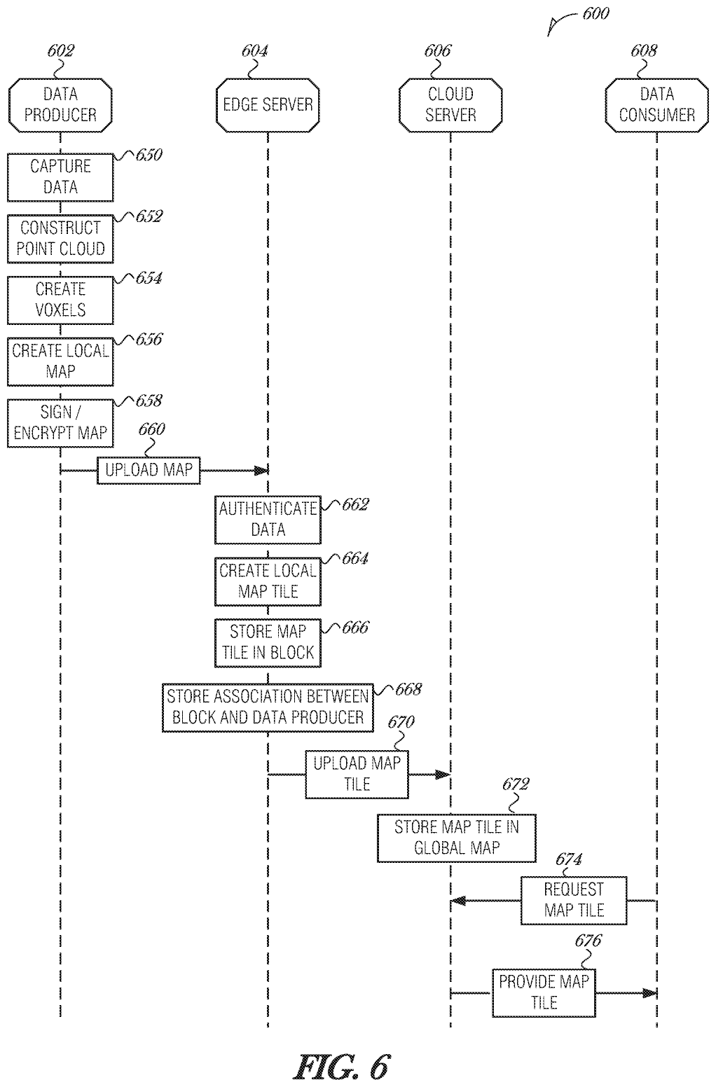

FIG. 6 is a swim lane diagram illustrating a process 600 for secure mapping operations, according to an embodiment. A data producer 602 (e.g., vehicle 500 or roadside sensor 506) captures sensor data (operation 650). The data may be any type of sensor data used to create, modify, update, generate, or edit maps. Example data includes, but is not limited to image data, LIDAR data, infrared data, or the like. The data producer constructs a point cloud from the captured sensed data (operation 652) and creates registered voxels (operation 654). Voxels are volumetric pixels (e.g., a three-dimensional pixel). Registering voxels includes the process of finding a correspondence between the sensed voxels and previously-known landmarks, positions, or coordinates. Voxel registration aligns the sensed voxels with objects in a map tile providing a mechanism to compare coordinates of the sensed object and the previously-recorded object. A local map is created from the registered voxels (operation 656). The local map may be based on a previously-obtained map tile, such that the local map represents a revision of the map tile with the new registered voxel data. Alternatively, the local may be objects available in the field-of-view of the data producer 602, which may be aggregated with other objects to create a local map tile.

The data producer 602 signs and optionally encrypts the map data (operation 658) and uploads the map data to a server system 604 (e.g., edge server 508) (operation 660). In an embodiment, the data producer 602 may use a private key to sign and encrypt the map data. The server system 604 may then use a public key associated with the data producer 602 to decrypt it. Alternatively, the data producer 602 may obtain a public key of the server system 604, and encrypt the map data with the server system's public key, allowing the server system 604 to decrypt it using a corresponding private key. As another alternative, a symmetric key may be used to encrypt and decrypt the map data.

The server system 604 may serve one or more data producers 602. The server system 604 authenticates and verifies the map data (operation 662) and if the map data is authentic, the server system 604 creates a local map tile (operation 664). The server system 604 may use map data from several data producers 602 to create the local map tile.

The local map tile is then stored in a block, which will be appended to a blockchain (operation 666). A block identifier (ID) is obtained when the block is successfully added to the blockchain. The block ID is stored with an identifier that uniquely identifies the data producer 602. The identifier may be the data producer's public key. The identifier may be a network address or an assigned unique identifier associated with hardware, a vehicle, a vehicle operator, or the like. The identifier is stored with the block ID in a data store. The data store used to store the association between the identifier and block ID may be a blockchain or other immutable, secure storage system (operation 668).

The server system 604 may upload the local map tile to a cloud server system 606 (operation 670). The server system 604 may be physically positioned closer to the data producer 602 such that the server system 604 has less latency in communications with the data producer 602. For instance, there may be a server system 604 for each square mile of an urban environment to service data producers 602 in the environment. This may result in hundreds or thousands of server systems 604 for a larger metropolitan area. The cloud server system 606 assembles the local map tiles received from the server systems 604 and stores them compiled local maps as a master map (operation 672).

A data consumer 608 (e.g., vehicle 500) may authenticate to the cloud server system 606 and request map tiles for use in navigation (operation 674). The data consumer 608 may communicate through a similar communication pathway as the data producer 602 (e.g., through server system 620). The cloud server 606 provides the requested map tile (operation 676).

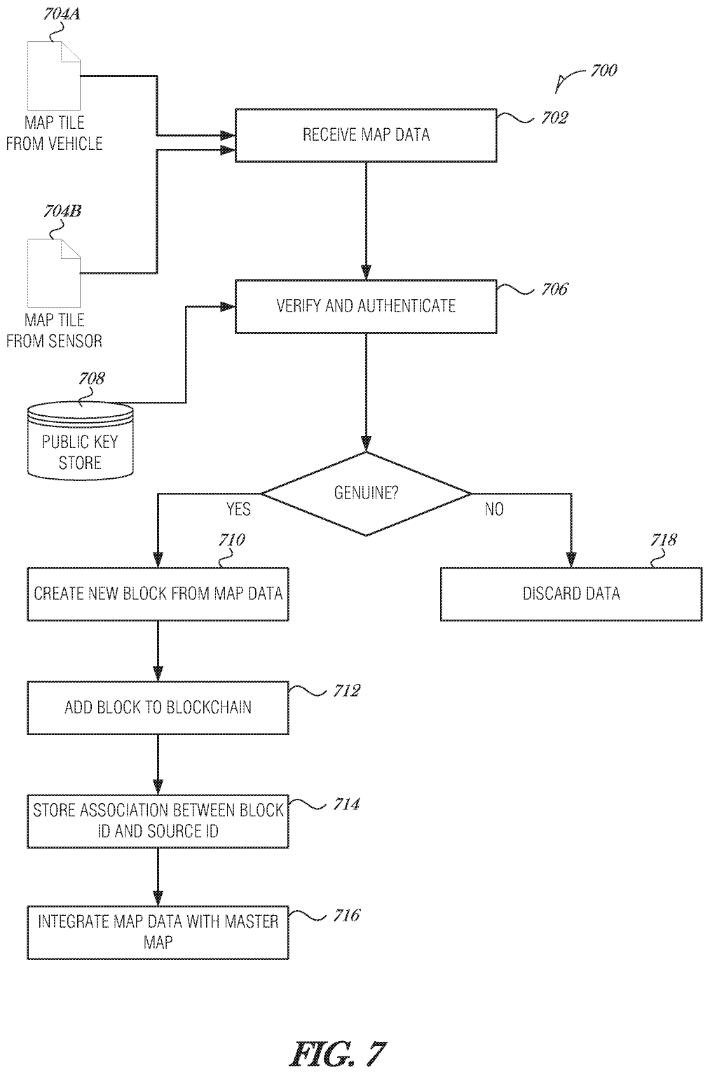

FIG. 7 is a flowchart illustrating a method 700 for providing secure mapping operations, according to an embodiment. At 702, map data is received at a server from data sources 704A or 704B. Data sources 704A-B may be vehicles, roadside units, roadside sensors, drones, or the like. Data sources 704A-B may provide map data in the form of raw sensor data, map data, map tiles, or the like. Data may be formatted using a standard description language, such as JavaScript Object Notation (JSON).

Map data may represent a full map tile, changes to an existing map tile, or other data used to manage a map tile. The map data may be used in different layers of a map tile. Map tiles are often separated into different layers including layers such as a base layer, a geometric map layer, a semantic map layer, a map priors layer, and a real-time layer. Some map tiles may have more or fewer layers than described here. A base layer is the standard definition map and may be based on survey data, existing map data, and the like. The geometric map layer may include objects derived from raw sensor data from LIDAR, radar, cameras, GPS, etc. The semantic layer includes things like lane boundaries, intersections, parking spots, traffic controls lights or signs, etc. that include rich information for vehicle control. The map priors layer includes insights into the semantic layer, such as the average wait times at a light or average speeds over a road segment. The real-time layer includes dynamically updated real-time traffic or incident (e.g., accident, road failure, etc.) information. The map data may include data from one or several layers.

At 706, the received map data is verified and authenticated. In an embodiment, the data source 704A-B signs the map data using a certificate. In an embodiment, the data source 704A-B encrypts the map data using a symmetric key, the data source's private key, the server's public key, or with other encryption keys. The server authenticates the validity of the certificate and signature using a pre-stored public key 708 associated with the data source 704A-B. The server may optionally access a public key provided by the data source 704A-B in the certificate to validate the signature.

If the server determines that the certificate is not genuine or recognized, then the map data is discarded (operation 718). Otherwise, the method 700 continues and a new block is created from the map data or the map data is appended to a block being formed (operation 710). The map data may be compiled into a map tile to be stored in the new block. Optionally, the new block may store a portion of a map tile.

Blocks are added to a blockchain or other publicly-available immutable log (operation 712). When the block is formed, a block identifier (ID) is obtained that uniquely identifies the block. The block ID is stored with the public key 708 associated with the data source 704A-B in a data store (operation 714). The block ID-public key association is used to track who contributed data to form the block. This block ID-public key association may be stored in a different blockchain or immutable ledger to keep the information safe. The map data is then integrated with a master map, which includes multiple tiles (e.g., a world map) (operation 716).

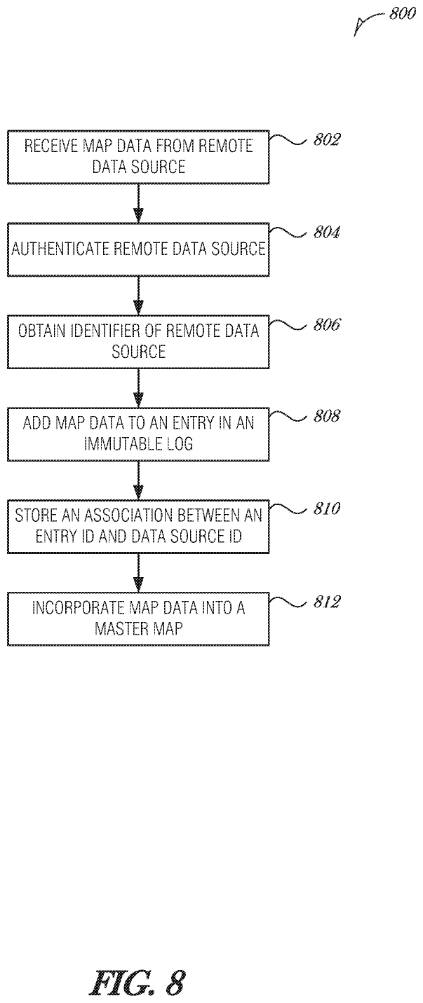

FIG. 8 is a flowchart illustrating a method 800 for providing secure mapping operations, according to an embodiment. At 802, map data from a remote data source is received at a computer server. In an embodiment, the remote data source is a vehicle. In an embodiment, the remote data source is a roadside sensor. In an embodiment, the remote data source is a drone.

In an embodiment, the map data is a map tile. In an embodiment, the map data is a portion of a map tile. In an embodiment, the map data is encrypted.

At 804, the remote data source is authenticated. In an embodiment, authenticating the data source includes examining a certificate provided by the remote data source and authenticating the data source based on the certificate. In a further embodiment, obtaining the identifier of the remote data source includes obtaining a public key associated with the certificate provided by the remote data source.

At 806, an identifier of the remote data source is obtained. In an embodiment, the identifier of the remote data source is a public key of the remote data source. In an embodiment, the identifier of the remote data source is a network address of the remote data source. In an embodiment, the identifier of the remote data source is a globally unique identifier assigned to the remote data source.

At 808, the map data is added to an entry in an immutable log when the remote data source is authenticated, the entry having an entry identifier. In an embodiment, the immutable log is a blockchain. In a further embodiment, the entry identifier is a block identifier.

At 810, an association between the identifier of the remote data source and the entry identifier is stored in a secure store. In an embodiment, the secure store is a blockchain.

At 812, the map data is incorporated into a master map.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), system on-chip (SoC), desktop computers, laptop computers, tablet computers, servers, smart phones, etc.

As used in any embodiment herein, the term “logic” may refer to firmware and/or circuitry configured to perform any of the aforementioned operations. Firmware may be embodied as code, instructions or instruction sets and/or data that are hard-coded (e.g., nonvolatile) in memory devices and/or circuitry.

“Circuitry,” as used in any embodiment herein, may comprise, for example, singly or in any combination, hardwired circuitry, programmable circuitry, state machine circuitry, logic and/or firmware that stores instructions executed by programmable circuitry. The circuitry may be embodied as an integrated circuit, such as an integrated circuit chip. In some embodiments, the circuitry may be formed, at least in part, by the processor circuitry executing code and/or instructions sets (e.g., software, firmware, etc.) corresponding to the functionality described herein, thus transforming a general-purpose processor into a specific-purpose processing environment to perform one or more of the operations described herein. In some embodiments, the processor circuitry may be embodied as a stand-alone integrated circuit or may be incorporated as one of several components on an integrated circuit. In some embodiments, the various components and circuitry of the node or other systems may be combined in a system-on-a-chip (SoC) architecture

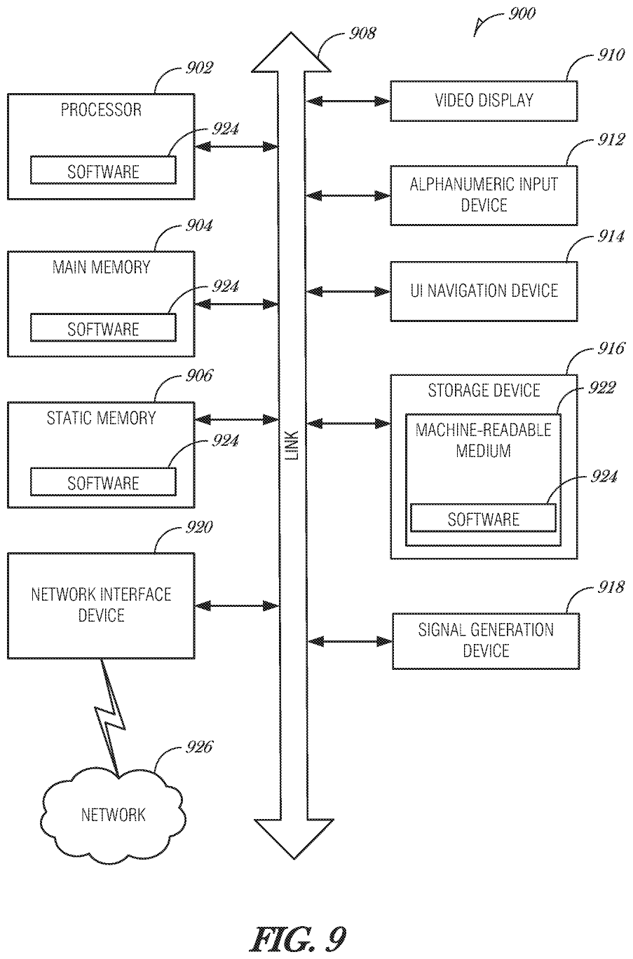

FIG. 9 is a block diagram illustrating a machine in the example form of a computer system 900, within which a set or sequence of instructions may be executed to cause the machine to perform any one of the methodologies discussed herein, according to an embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a vehicle subsystem, a personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 900 includes at least one processor 902 (e.g., a central processing unit (CPU), a graphics processing unit (GPU) or both, processor cores, compute nodes, etc.), a main memory 904 and a static memory 906, which communicate with each other via a link 908 (e.g., bus). The computer system 900 may further include a video display unit 910, an alphanumeric input device 912 (e.g., a keyboard), and a user interface (UI) navigation device 914 (e.g., a mouse). In one embodiment, the video display unit 910, input device 912 and UI navigation device 914 are incorporated into a touch screen display. The computer system 900 may additionally include a storage device 916 (e.g., a drive unit), a signal generation device 918 (e.g., a speaker), a network interface device 920, and one or more sensors (not shown), such as a global positioning system (GPS) sensor, compass, accelerometer, gyrometer, magnetometer, or other sensor.

The storage device 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904, static memory 906, and/or within the processor 902 during execution thereof by the computer system 900, with the main memory 904, static memory 906, and the processor 902 also constituting machine-readable media.

While the machine-readable medium 922 is illustrated in an example embodiment to be a single medium, the term “machine-readable medium” may include a single medium or multiple media (e.g., a centralized or distributed database, and/or associated caches and servers) that store the one or more instructions 924. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 924 may further be transmitted or received over a communications network 926 using a transmission medium via the network interface device 920 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., LTE C-V2X WWAN, a SRC/ETSI ITS-G5 (WLAN) communication network, Bluetooth, Wi-Fi, 3G, and 4G LTE/LTE-A, 5G, DSRC, or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples

Example 1 is a system for implementing secure high-definition map services, the system comprising: a processor subsystem; and a storage including instructions, which when executed by the processor subsystem, cause the processor subsystem to: receive map data from a remote data source; authenticate the remote data source; obtain an identifier of the remote data source; add the map data to an entry in an immutable log when the remote data source is authenticated, the entry having an entry identifier; store an association between the identifier of the remote data source and the entry identifier in a secure store; and incorporate the map data into a master map.

In Example 2, the subject matter of Example 1 includes, wherein the remote data source is a vehicle.

In Example 3, the subject matter of Examples 1-2 includes, wherein the remote data source is a roadside sensor.

In Example 4, the subject matter of Examples 1-3 includes, wherein the remote data source is a drone.

In Example 5, the subject matter of Examples 1˜4 includes, wherein the map data is a map tile.

In Example 6, the subject matter of Examples 1-5 includes, wherein the map data is a portion of a map tile.

In Example 7, the subject matter of Examples 1-6 includes, wherein the map data is encrypted.

In Example 8, the subject matter of Examples 1-7 includes, wherein to authenticate the data source, the instructions cause the processor subsystem to: examine a certificate provided by the remote data source; and authenticate the data source based on the certificate.

In Example 9, the subject matter of Example 8 includes, wherein to obtain the identifier of the remote data source, the instructions cause the processor subsystem to obtain a public key associated with the certificate provided by the remote data source.

In Example 10, the subject matter of Examples 1-9 includes, wherein the identifier of the remote data source is a public key of the remote data source.

In Example 11, the subject matter of Examples 1-10 includes, wherein the identifier of the remote data source is a network address of the remote data source.

In Example 12, the subject matter of Examples 1-11 includes, wherein the identifier of the remote data source is a globally unique identifier assigned to the remote data source.

In Example 13, the subject matter of Examples 1-12 includes, wherein the immutable log is a blockchain.

In Example 14, the subject matter of Example 13 includes, wherein the entry identifier is a block identifier.

In Example 15, the subject matter of Examples 1-14 includes, wherein the secure store is a blockchain.

Example 16 is a method of implementing secure high-definition map services, the method comprising: receiving, at a computer server, map data from a remote data source; authenticating the remote data source; obtaining an identifier of the remote data source; adding the map data to an entry in an immutable log when the remote data source is authenticated, the entry having an entry identifier; storing an association between the identifier of the remote data source and the entry identifier in a secure store; and incorporating the map data into a master map.

In Example 17, the subject matter of Example 16 includes, wherein the remote data source is a vehicle.

In Example 18, the subject matter of Examples 16-17 includes, wherein the remote data source is a roadside sensor.

In Example 19, the subject matter of Examples 16-18 includes, wherein the remote data source is a drone.

In Example 20, the subject matter of Examples 16-19 includes, wherein the map data is a map tile.

In Example 21, the subject matter of Examples 16-20 includes, wherein the map data is a portion of a map tile.

In Example 22, the subject matter of Examples 16-21 includes, wherein the map data is encrypted.

In Example 23, the subject matter of Examples 16-22 includes, wherein authenticating the data source comprises: examining a certificate provided by the remote data source; and authenticating the data source based on the certificate.

In Example 24, the subject matter of Example 23 includes, wherein obtaining the identifier of the remote data source comprises obtaining a public key associated with the certificate provided by the remote data source.

In Example 25, the subject matter of Examples 16-24 includes, wherein the identifier of the remote data source is a public key of the remote data source.

In Example 26, the subject matter of Examples 16-25 includes, wherein the identifier of the remote data source is a network address of the remote data source.

In Example 27, the subject matter of Examples 16-26 includes, wherein the identifier of the remote data source is a globally unique identifier assigned to the remote data source.

In Example 28, the subject matter of Examples 16-27 includes, wherein the immutable log is a blockchain.

In Example 29, the subject matter of Example 28 includes, wherein the entry identifier is a block identifier.

In Example 30, the subject matter of Examples 16-29 includes, wherein the secure store is a blockchain.

Example 31 is at least one machine-readable medium including instructions, which when executed by a machine, cause the machine to perform operations of any of the methods of Examples 16-30.

Example 32 is an apparatus comprising means for performing any of the methods of Examples 16-30.

Example 33 is an apparatus for implementing secure high-definition map services, the apparatus comprising: means for receiving, at a computer server, map data from a remote data source; means for authenticating the remote data source; means for obtaining an identifier of the remote data source; means for adding the map data to an entry in an immutable log when the remote data source is authenticated, the entry having an entry identifier; means for storing an association between the identifier of the remote data source and the entry identifier in a secure store; and means for incorporating the map data into a master map.

In Example 34, the subject matter of Example 33 includes, wherein the remote data source is a vehicle.

In Example 35, the subject matter of Examples 33-34 includes, wherein the remote data source is a roadside sensor.

In Example 36, the subject matter of Examples 33-35 includes, wherein the remote data source is a drone.

In Example 37, the subject matter of Examples 33-36 includes, wherein the map data is a map tile.

In Example 38, the subject matter of Examples 33-37 includes, wherein the map data is a portion of a map tile.

In Example 39, the subject matter of Examples 33-38 includes, wherein the map data is encrypted.

In Example 40, the subject matter of Examples 33-39 includes, wherein the means for authenticating the data source comprise: means for examining a certificate provided by the remote data source; and means for authenticating the data source based on the certificate.

In Example 41, the subject matter of Example 40 includes, wherein the means for obtaining the identifier of the remote data source comprise means for obtaining a public key associated with the certificate provided by the remote data source.

In Example 42, the subject matter of Examples 33-41 includes, wherein the identifier of the remote data source is a public key of the remote data source.

In Example 43, the subject matter of Examples 33-42 includes, wherein the identifier of the remote data source is a network address of the remote data source.

In Example 44, the subject matter of Examples 33-43 includes, wherein the identifier of the remote data source is a globally unique identifier assigned to the remote data source.

In Example 45, the subject matter of Examples 33-44 includes, wherein the immutable log is a blockchain.

In Example 46, the subject matter of Example 45 includes, wherein the entry identifier is a block identifier.

In Example 47, the subject matter of Examples 33-46 includes, wherein the secure store is a blockchain.

Example 48 is at least one machine-readable medium including instruction for implementing secure high-definition map services, which when executed by a machine, cause the machine to: receive map data from a remote data source; authenticate the remote data source; obtain an identifier of the remote data source; add the map data to an entry in an immutable log when the remote data source is authenticated, the entry having an entry identifier; store an association between the identifier of the remote data source and the entry identifier in a secure store; and incorporate the map data into a master map.

In Example 49, the subject matter of Example 48 includes, wherein the remote data source is a vehicle.

In Example 50, the subject matter of Examples 48-49 includes, wherein the remote data source is a roadside sensor.

In Example 51, the subject matter of Examples 48-50 includes, wherein the remote data source is a drone.

In Example 52, the subject matter of Examples 48-51 includes, wherein the map data is a map tile.

In Example 53, the subject matter of Examples 48-52 includes, wherein the map data is a portion of a map tile.

In Example 54, the subject matter of Examples 48-53 includes, wherein the map data is encrypted.

In Example 55, the subject matter of Examples 48-54 includes, wherein to authenticate the data source, the instructions cause the processor subsystem to: examine a certificate provided by the remote data source; and authenticate the data source based on the certificate.

In Example 56, the subject matter of Example 55 includes, wherein to obtain the identifier of the remote data source, the instructions cause the processor subsystem to obtain a public key associated with the certificate provided by the remote data source.

In Example 57, the subject matter of Examples 48-56 includes, wherein the identifier of the remote data source is a public key of the remote data source.

In Example 58, the subject matter of Examples 48-57 includes, wherein the identifier of the remote data source is a network address of the remote data source.

In Example 59, the subject matter of Examples 48-58 includes, wherein the identifier of the remote data source is a globally unique identifier assigned to the remote data source.

In Example 60, the subject matter of Examples 48-59 includes, wherein the immutable log is a blockchain.

In Example 61, the subject matter of Example 60 includes, wherein the entry identifier is a block identifier.

In Example 62, the subject matter of Examples 48-61 includes, wherein the secure store is a blockchain.

Example 63 is at least one machine-readable medium including instructions that, when executed by processing circuitry, cause the processing circuitry to perform operations to implement of any of Examples 1-62.

Example 64 is an apparatus comprising means to implement of any of Examples 1-62.

Example 65 is a system to implement of any of Examples 1-62.

Example 66 is a method to implement of any of Examples 1-62.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1.-24. (canceled)

25. A system for implementing secure high-definition map services, the system comprising:
a processor subsystem; and
a storage including instructions, which when executed by the processor subsystem, cause the processor subsystem to:
receive map data from a remote data source;
authenticate the remote data source;
obtain an identifier of the remote data source;
add the map data to an entry in an immutable log when the remote data source is authenticated, the entry having an entry identifier;
store an association between the identifier of the remote data source and the entry identifier in a secure store; and
incorporate the map data into a master map.

26. The system of claim 25, wherein the remote data source is a vehicle.

27. The system of claim 25, wherein the remote data source is a roadside sensor.

28. The system of claim 25, wherein the remote data source is a drone.

29. The system of claim 25, wherein the map data is a map tile.

30. The system of claim 25, wherein the map data is a portion of a map tile.

31. The system of claim 25, wherein the map data is encrypted.

32. The system of claim 25, wherein to authenticate the data source, the instructions cause the processor subsystem to:
examine a certificate provided by the remote data source; and
authenticate the data source based on the certificate.

33. The system of claim 32, wherein to obtain the identifier of the remote data source, the instructions cause the processor subsystem to obtain a public key associated with the certificate provided by the remote data source.

34. The system of claim 25, wherein the identifier of the remote data source is a public key of the remote data source.

35. The system of claim 25, wherein the identifier of the remote data source is a network address of the remote data source.

36. The system of claim 25, wherein the identifier of the remote data source is a globally unique identifier assigned to the remote data source.

37. The system of claim 25, wherein the immutable log is a blockchain.

38. The system of claim 37, wherein the entry identifier is a block identifier.

39. The system of claim 25, wherein the secure store is a blockchain.

40. A method of implementing secure high-definition map services, the method comprising:
receiving, at a computer server, map data from a remote data source;
authenticating the remote data source;
obtaining an identifier of the remote data source;
adding the map data to an entry in an immutable log when the remote data source is authenticated, the entry having an entry identifier;
storing an association between the identifier of the remote data source and the entry identifier in a secure store; and
incorporating the map data into a master map.

41. The method of claim 40, wherein authenticating the data source comprises:
examining a certificate provided by the remote data source; and
authenticating the data source based on the certificate.

42. The method of claim 41, wherein obtaining the identifier of the remote data source comprises obtaining a public key associated with the certificate provided by the remote data source.

43. The method of claim 40, wherein the identifier of the remote data source is a public key of the remote data source.

44. The method of claim 40, wherein the identifier of the remote data source is a network address of the remote data source.

45. The method of claim 40, wherein the identifier of the remote data source is a globally unique identifier assigned to the remote data source.

46. At least one machine-readable medium including instruction for implementing secure high-definition map services, which when executed by a machine, cause the machine to:
receive map data from a remote data source;
authenticate the remote data source;
obtain an identifier of the remote data source;
add the map data to an entry in an immutable log when the remote data source is authenticated, the entry having an entry identifier;
store an association between the identifier of the remote data source and the entry identifier in a secure store; and
incorporate the map data into a master map.

47. The at least one machine-readable medium of claim 46, wherein the immutable log is a blockchain.

48. The at least one machine-readable medium of claim 47, wherein the entry identifier is a block identifier.

49. The at least one machine-readable medium of claim 46, wherein the secure store is a blockchain.
